(19) United States
(12) Patent Application Publication
(10) Pub. No.: US 2008/0184169 A1
(43) Pub. Date: Jul. 31, 2008

(54) SYSTEM AND METHOD FOR MANAGING TOOLBARS ON A WEB PAGE

(75) Inventors: CHUNG-I LEE, Tu-Cheng (TW); XIN-YU HUANG, Shenzhen (CN); WEN-HAO WU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 11/847,355

(22) Filed: Aug. 30, 2007

(30) Foreign Application Priority Data
Jan. 26, 2007 (CN) 200710200116.X

(51) Int. Cl. G06F 3/048

(52) U.S. Cl. 715/840

(57) ABSTRACT

A method for managing toolbar on a web page includes the steps of: separating a web page into a toolbar area (1) and a content area (2); registering a function button (3) in the content area by means of registering an identification of the function button; creating an image icon (4) in the toolbar area, the image icon corresponding to the registered function button; and mapping the registered function button to the image icon, thereby functions of the registered function button can be executed by clicking the image icon. A related system is also provided.

### BACKGROUND OF THE INVENTION

1. Field of the Invention

The present invention generally related to systems and methods for managing toolbars, and more particularly to a system and method for managing toolbars on a web page.

2. Description of Related Art

A web page is a resource of information that is suitable for the World Wide Web and can be accessed through a web browser. This information is usually in the HTML or XHTML format, and may provide navigations to other web pages via hypertext links. In a graphical user interface (GUI) on a computer monitor, a toolbar is a row, column, or block of onscreen buttons or icons, when clicked, activates certain functions of programs installed on the computer.

The toolbar is convenient for users to manage the web pages. However, the limited toolbars on the web browser cannot satisfy users and the web browser does not allow the users to modify or create additional toolbars according to personal favorites.

Accordingly, what is needed is a system and method for managing toolbars on the web page, which can facilitate managing the toolbars on the web page and the content area of the web page, and further adding and deleting buttons of the toolbars.

### SUMMARY OF THE INVENTION

One preferred embodiment provides a system for managing toolbar on a web page. The system includes a separating module, a registering module, a creating module and a mapping module. The separating module is configured for separating a web page into a toolbar area and a content area. The registering module is configured for registering a function button in the content area by means of registering an identification of the function button. The creating module is configured for creating an image icon in the toolbar area, the image icon corresponds to the registered function button. The mapping module is configured for mapping the registered function button to the image icon, thereby functions of the registered function button can be executed by clicking the image icon.

Another preferred embodiment provides a method for managing toolbar on a web page. The method includes the steps of: separating a web page into a toolbar area and a content area; registering a function button in the content area by means of registering an identification of the function button; creating an image icon in the toolbar area, the image icon corresponding to the registered function button; and mapping the registered function button to the image icon, thereby functions of the registered function button can be executed by clicking the image icon.

Other systems, methods, features, and advantages will be or become apparent to one skilled in the art upon examination of the following drawings and detailed description.

### BRIEF DESCRIPTION OF THE DRAWINGS

FIG. 1 is a block diagram of a system for managing toolbars on a web page in accordance with one preferred embodiment;

FIG. 2 is a block diagram of function modules of an application server in FIG. 1

FIG. 3 is a block diagram of a web page in accordance with one preferred embodiment; and

FIG. 4 is a flowchart of a method for managing toolbars on a web page in accordance with one preferred embodiment.

### DETAILED DESCRIPTION OF THE INVENTION

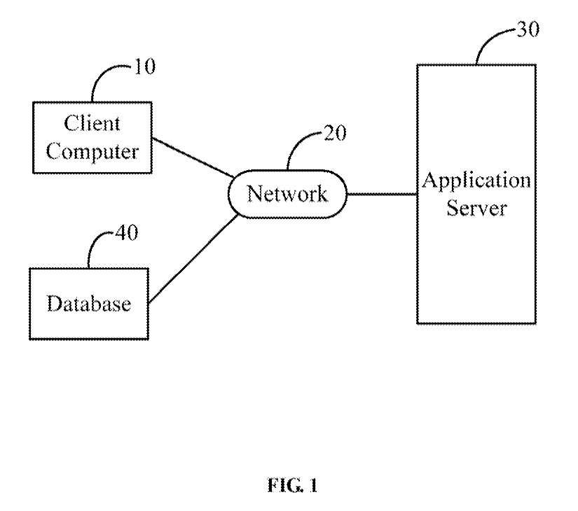

FIG. 1 is a block diagram of a system for managing toolbars on a web page in accordance with one preferred embodiment. The system mainly includes a client computer 10, a network 20, an application server 30 and a database 40. The application server 30 is connected with the client computer 10 and the database 40 via the network 20.

The client computer 10 can be a notebook computer, a desktop computer, or other web enabled device. The client computer 10 is configured for providing a user interface (UI) for users to manage toolbars on the web page. The application server 30 can be a desktop server, a rack mount server, a pedestal server, or a blade server. The database 40 is a storage device, such as a harddisk. The database 40 is configured for storing web pages and other types of data.

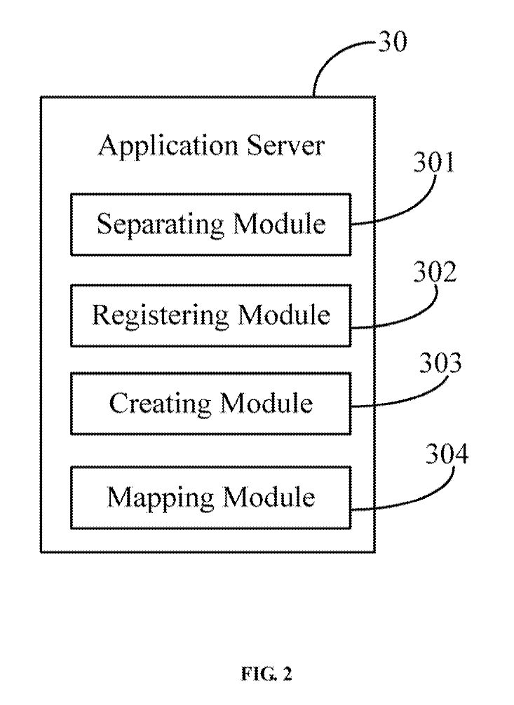

FIG. 2 is a block diagram of function modules of the application server in FIG. 1. The application server 30 includes a separating module 301, a registering module 302, a creating module 303 and a mapping module 304.

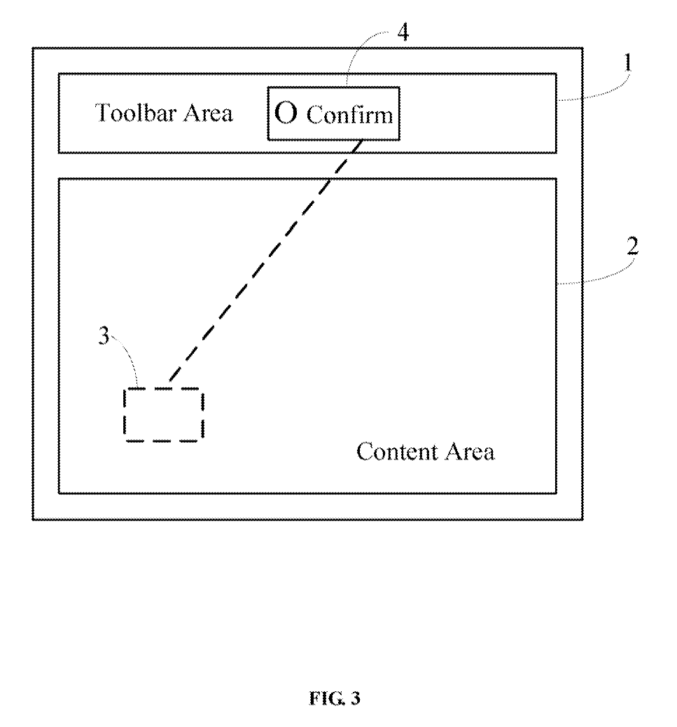

The separating module 301 is configured for separating the web page into a toolbar area and a content area. The separation of the toolbar area 1 and the content area 2 are presented in FIG. 3. The toolbar area 1 is used for storing and displaying image icons. The content area 2 is used for storing contents of the web page and configuring function buttons to manage and operate the content area 2.

The registering module 302 is configured for registering a function button in the content area by means of registering an identification of the function button, and hiding the registered function button in the content area 2. The registered function button contains some specific functions, such as functions for managing and operating the content area 2, etc. For example, in FIG. 3, the registering module 302 invokes a setting function SetButton to register a function button 3 in the content area 2, and invokes a function, such as HideButton, to hide the registered function button 3 in the content area 2.

The creating module 303 is configured for creating an image icon in the toolbar area 1, the image icon corresponds to the registered function button. For example, in FIG. 3, the creating module 302 invokes a function AddToolBarltem to create an image icon 4 corresponding to the function button 3.

The mapping module 304 is configured for mapping the registered function button to the image icon, thereby the functions of the registered function button can be executed by clicking the image icon. For example, in FIG. 3, the mapping module 304 maps the function button 3 to the image icon 4, then users can manage and operate the content area 2 by clicking the image icon 4 in the toolbar area 1.

FIG. 3 is a block diagram of a web page in accordance with one preferred embodiment. Firstly, the separating module 301 separates the web page into a toolbar area and a content area. Secondly, the registering module 302 invokes a setting function, such as SetButton, to register a function button 3 in the content area 2, and invokes a function, such as HideButton, to hide the registered function button 3 in the content area 2. Thirdly, the creating module 302 invokes a function, such as AddToolBarltem, to create an image icon 4 corresponding to the function button 3. Finally, the mapping module 304 maps the function button 3 to the image icon 4, which allow users to manage and operate the content area 2 by clicking the image icon 4 in the toolbar area 1.

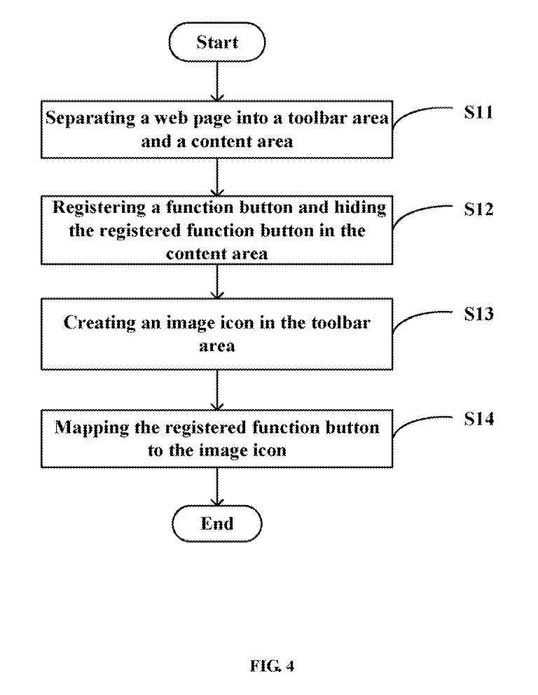

FIG. 4 is a flowchart of a method for managing toolbars on a web page in accordance with one preferred embodiment.

In step S11, the separating module 301 separates the web page into a toolbar area 1 and a content area 2.

In step S12, the registering module 302 registers a function button by means of registering an identification of the function button, and hides the registered function button in the content area 2. The registered function button contains some specific functions, such as functions of managing and operating the content area 2, etc.

In step S13, the creating module 303 creates an image icon in the toolbar area 1, the image icon corresponds to the registered function button.

In step S14, the mapping module 304 maps the registered function button to the image icon, thereby the function of the registered function button can be executed by clicking the image icon.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for managing toolbar on a web page, the system comprising:
a separating module for separating a web page into a toolbar area and a content area;
a registering module for registering a function button in the content area by means of registering an identification of the function button;
a creating module for creating an image icon in the toolbar area, the image icon corresponds to the registered function button; and
a mapping module for mapping the registered function button to the image icon, thereby functions of the registered function button can be executed by clicking the image icon.

2. The system according to claim 1, wherein the registering module is further used for hiding the registered function button in the content area.

3. A method for managing toolbar on a web page, the method comprising the steps of:
separating a web page into a toolbar area and a content area;
registering a function button in the content area by means of registering an identification of the function button;
creating an image icon in the toolbar area, the image icon corresponding to the registered function button; and
mapping the registered function button to the image icon, thereby functions of the registered function button can be executed by clicking the image icon.

4. The method according to claim 4, wherein the method further comprising the step of hiding the registered function button in the content area.
